(19) United States
(12) Patent Application Publication
(10) Pub. No.: US 2014/0375150 A1
(43) Pub. Date: Dec. 25, 2014

(54) HIGH-EFFICIENCY COMPOUND DIELECTRIC MOTORS

(71) Applicant: Reginald Miller, Chula Vista, CA (US)

(72) Inventor: Reginald Miller, Chula Vista, CA (US)

(21) Appl. No.: 14/318,309

(22) Filed: Jun. 27, 2014

Related U.S. Application Data
(63) Continuation-in-part of application No. 14/098,526, filed on Dec. 5, 2013, now abandoned.
Application No. 14/098,526 is a continuation-in-part of application No. 13/915,624, filed on Jun. 11, 2013, now abandoned.
Application No. 13/915,624 is a continuation-in-part of application No. 13/676,040, filed on Nov. 13, 2012, now abandoned.
(60) Provisional application No. 61/558,210, filed on Nov. 10, 2011.

(51) Int. Cl. H02K 3/47; H02K 3/30; H02K 1/27; H02K 3/02; H02K 11/00

(52) U.S. Cl. CPC H02K 3/47; H02K 3/02; H02K 11/0073; H02K 1/27; H02K 3/30
USPC 310/43; 310/208; 310/68 D

(57) ABSTRACT

A high-efficiency electric motor generally comprises one or more high-winding inductive coils and a rotor element coupled to one or more permanent magnets for creating rotation driven by the inductive coils, wherein the motor is optimized using dielectric materials for reduced loss. Reduced loss is achieved in several ways, for example by reducing eddy currents, hysteresis, and magnetic drag presented by ferrous and other metallic materials. Thus, the inductive coils generally comprise a dielectric core, as opposed to a metallic or ferrous core material since such materials can create magnetic drag, eddy currents, and hysteresis leading to power loss. Moreover, the motor housing and other motor components may comprise a dielectric material for further reduced energy loss and enhancement of motor efficiency. Other features related to a recycling circuit of certain embodiments wherein energy from a collapsing field of the coils is reused.

### CROSS_REFERENCE TO RELATED APPLICATIONS

This application is a continuation in part (CIP) of U.S. Ser. No. 14/098,526, filed Dec. 5, 2013, titled “HIGH EFFICIENCY COMPOUND DIELECTRIC MOTORS”;

which is a CIP of U.S. Ser. No. 13/915,624, filed Jun. 11, 2013, and titled “HIGH EFFICIENCY COMPOUND DIELECTRIC MOTORS”;

which is a CIP of U.S. Ser. No. 13/676,040, filed Nov. 13, 2012, and titled “HIGH EFFICIENCY ELECTRIC MOTOR”;

which claims benefit of priority with US. Provisional Ser. No. 61/558,210, filed Nov. 10, 2011;

the contents of each of which are hereby incorporated by reference.

### BACKGROUND OF THE INVENTION

1. Field of the Invention

This invention relates to electric motors; and more particularly to high efficiency electric motors utilizing high-winding inductive coils and dielectric core materials for reduced loss and improved efficiency.

2. Description of the Related Art

Electric motors are appreciated in a number of applications, and have been described in a myriad of designs and implementations. Moreover, such electric motors when operated in reverse direction can be adapted to generate electricity from input mechanical energy, commonly referred to as “generators”, or in some instances as “alternators”. Of these motors known in the art, none have been successful in operating at relatively high efficiencies (greater than 75%), and such conventional electric motors tend to expel energy in various forms including heat, hysteresis, eddy currents, and magnetic drag; collectively referred to herein as “loss”.

The fundamentals of alternating current (AC) and direct current (DC) electric motors are well documented in the art, and thus will not be described in detail here. However, an excellent summary of electric motors can be found with a search for “electric motor” at www.Wikipedia.com, or with an internet search.

AC induction motors have been commonly available for more than one hundred years. These motors use soft iron extensively and thus result in loss resulting from hysteresis, eddy currents, and magnetic drag. Although prior art electric motors are functional, there is a present demand for electric motors with reduced loss and improved efficiency.

More recently, certain electric motors have been provided which utilize a secondary boost from permanent magnets in addition to the traditional soft-iron components. These electric motors, termed herein as “compound motors”, tend to be more efficient since the permanent magnets do not require electricity to drive their associated magnetic field(s), thus the motor output is compounded with the addition of permanent magnets to the induction motor topology.

With the advancement of modern technologies and modern global energy policies comes a need for more efficient electric motors to combat the limited supply of energy and increasing demand as well as the increasing energy prices associated therewith. These more efficient motors will power appliances and devices such as air conditioners, clothing appliances, and electric and hybrid automobiles, among many others.

Though a number of improvements have recently become introduced, there remains a long felt need for high efficiency motors configured to reduce, reuse or recycle waste energy within the motor itself. Current ferrite core motors tend to waste energy in the form of loss. Future motors will require reduced loss and reduced or eliminated ferrous materials within the motor itself.

### SUMMARY OF THE INVENTION

Various improvements and novel configurations for high efficiency electric motors are described herein. Embodiments include a compound dielectric motor and a compound regenerative dielectric motor, each being configured to provide reduced loss and improved efficiency.

The compound dielectric motor is an improvement over prior art compound electric motors, the improvement includes removal of all iron from the motor which results in reduced loss from heat, hysteresis, eddy currents, and magnetic drag. In the place of ferrous core materials, permanent magnets, such as neodymium magnets are used in conjunction with novel high-winding inductive coils to produce sufficient mechanical horsepower without the traditional loss to magnetic components. In addition, solid state electronics are used to significantly reduce or eliminate sparking. The result is an electric motor configured to produce comparable mechanical torque with reduced input energy, and improved motor efficiency. Moreover, the reduced sparking tends to provide reduced oxidation and wear of components, leading to prolonged durability and improved motor performance.

In certain embodiments, the compound dielectric motor is configured to reuse energy being expelled in collapsing fields of the inductive coils, directing such collapsing field energy from a first coil to a subsequent source, to form what is herein referred to as a compound regenerative dielectric motor. In these embodiments, a diode or is disposed at a terminal lead of an inductive coil. Energy leaving the coil is directed into a subsequent source for reuse. The subsequent source can be a subsequent coil acting on a shared rotor; a subsequent coil acting on a distinct rotor; or another electrical device. In this regard, one or more coils within the motor can be configured to direct collapsing field energy into an alternative source for energy reuse.

Various embodiments of the compound dielectric motor and compound regenerative dielectric motor may include: a radial embodiment, a turbine embodiment, a piston embodiment, and a chain and sprocket embodiment as shown in the accompanying illustrations. Each of these high efficiency electric motors includes dielectric materials for significantly reducing loss from heat, hysteresis, eddy currents, and magnetic drag; one or more high-power permanent magnets; a plurality of high-winding coils; solid state electronics for switching and control of motor dynamics; and optional regenerative components such as diodes for redirecting and reusing collapsing field energy of one or more high-winding coils.

In certain other embodiments, methods for reducing loss associated with an electric motor are described herein.

### BRIEF DESCRIPTION OF THE DRAWINGS

These and other attributes of the invention are further described in the following detailed description, particularly when reviewed in conjunction with the drawings, wherein:

FIG. 1 shows a schematic of a compound dielectric motor in accordance with an embodiment.

FIG. 2 shows a schematic of a compound regenerative dielectric motor in accordance with another embodiment.

FIG. 3 shows side view of a high-winding inductive coil for use in various embodiments.

FIG. 4A shows a top view of a flat inductive coil.

FIG. 4B shows a top view of a curved inductive coil.

FIG. 5 shows a compound dielectric motor and various components in accordance with one embodiment.

FIG. 6A shows a perspective view of a compound dielectric motor and various components in accordance with another embodiment.

FIG. 6B shows a top view of the compound dielectric motor in accordance with the embodiment of FIG. 6A.

FIG. 6C shows a schematic of inductors, magnets, and switches in with a turbine motor similar to the embodiment of FIGS. 6(A-B).

FIG. 6D shows a switching circuit in accordance with the embodiment of FIGS. 6(A-C).

FIG. 6E shows a recycling circuit in accordance with the embodiment of FIGS. 6(A-D).

FIG. 6F shows a voltage source in accordance with the embodiment of FIGS. 6(A-E).

FIG. 7A shows a perspective view of a compound dielectric motor assembly in accordance with another embodiment.

FIG. 7B shows a side view of a compound dielectric motor and various components in accordance with the embodiment of FIG. 7A.

FIG. 7C shows a front view of a compound dielectric motor and various components in accordance with the embodiment of FIGS. 7(A-B).

FIG. 7D shows a top view of a compound dielectric motor and various components in accordance with the embodiment of FIGS. 7(A-C).

FIG. 8 shows a side view of a compound dielectric motor and various components in accordance with yet another embodiment.

### DETAILED DESCRIPTION OF THE PREFERRED EMBODIMENTS

In the following description, for purposes of explanation and not limitation, details and descriptions are set forth in order to provide a thorough understanding of the invention. However, it will be apparent to those skilled in the art that various features and benefits may be altered without departing from the spirit and scope of the invention.

A high efficiency electric motor is described. In the embodiments herein, ferrous materials and components that are common in traditional electric motors have been replaced with dielectric materials and components in order to remove loss associated with hysteresis, eddy currents, and magnetic drag. Because the soft-iron and ferrous components of traditional magnets are removed, a novel solution for improving power of the motor was developed including the introduction of high-winding inductive coils as described herein. The high-winding coils are designed to reduce energy loss due to heat. As such, fans and radial vanes are not required for cooling the motor, thus further reducing waste energy. Additionally, high power permanent magnets, such as for example, neodymium magnets, are utilized to improve magnetic field strength within the motor. Finally, solid state electronics are introduced with these embodiments for driving the dynamics of the motor without sparking. These and other features yield a much improved electric motor referred to as a “compound dielectric motor” as is described in the following embodiments.

In another aspect of the invention, the compound dielectric motor is further improved with a novel configuration for reusing collapsing field energy of one or more high-winding inductive coils for powering an alternative component or device, such as for powering a subsequent coil for driving a shared rotor or piston; powering a subsequent coil for driving a second and distinct rotor or piston; or for powering an additional electronic device. In these embodiments, each defining an embodiment of a “compound regenerative dielectric motor”, additional efficiency improvements are derived from recycling energy from the collapsing field of one or more high-winding inductive coils.

In another aspect, methods are described for reusing energy to form a compound regenerative dielectric motor.

It is one object of the invention to provide a high-efficiency electric motor for use in a variety of applications. The electric motor described herein provides improved efficiency over currently available motors by way of a variety of improvements.

In various embodiments, a high-efficiency electric motor generally comprises one or more high-winding inductive coils and a rotor element with a permanent magnet coupled to the rotor, wherein the motor is optimized for reduced loss. Reduced loss is achieved in several ways, for example by reducing eddy currents, hysteresis, and magnetic drag presented by ferrous and other metallic materials. Thus, the inductive coils generally comprise a dielectric core, as opposed to a metallic or ferrous core material since such materials can create magnetic drag, eddy currents, and hysteresis leading to power loss. Moreover, the motor housing and other motor components may comprise dielectric materials for further reduced energy loss and enhancement of motor efficiency.

In certain embodiments, the motor comprises a brass rotor, which provides reduced energy loss as described above. The permanent magnets are attached to the rotor. Thus, energy from the coils in the form of a magnetic field induces a rotation of the rotor and attached permanent magnets within the motor assembly. One or more permanent magnets can be designed for a specific motor application.

Bearings for use in the motor can be sleeve, ball bearings, or magnetic bearings.

The motor can be adapted to use carbon brush axle switching, or any solid state technique including the Hall effect.

In certain embodiments, the high efficiency motor is adapted to store electric field energy in the form of capacitance within the coils. Moreover, in certain embodiments a diode, selenium rectifier, or vacuum tube is provided for directing the collapsing electric field energy from a first coil into a second coil within a multi-coil motor, or from a first coil to a second device such as, for example, a battery charger. In this regard, electric field energy is reused for enhancing efficiency.

The coils generally comprise a relatively high number of windings, for example more than 1500 windings, creating a radial length that is substantially greater than the coil thickness, thus forming what is referred to herein as a “high-winding” coil or “flat coil”. With a large number of turns, more energy can be stored in the coils in the form of capacitance, which can then be redirected and reused within the motor. Moreover, the high number of windings provides a lower current requirement for achieving a desired inductance.

In certain embodiments, a metallic or ferrous core can be utilized within the coils where the benefits of field strength outweigh the associated loss. However, in a preferred embodiment the core will be dielectric and contain no metal, especially iron or other ferrous materials.

In one embodiment, the coil is contained within a dielectric material, such as by embedding in a plastic resin.

Moreover, the coil can comprise curved coil including a paraboloid shape, or hyperbolic paraboloid shape, for optimizing the magnetic field and motor response.

In some embodiments, one or more flat coils are each radially disposed about an aperture located at the center of each of three stators. A rotor extends through the apertures of the stators and comprises a plurality of discs attached thereto; the discs each comprise one or more permanent magnets, and preferably a neodymium magnet, though any permanent magnet may be used. A first coil or group of coils is energized to create a magnetic field which induces a torque about the permanent magnets and attached rotor. A second coil, or group of coils, is energized to continue the torque about the rotor element. This embodiment preferably recycles collapsing field energy from the first coil by directing current from the collapsing field toward a subsequent coil. In this regard, the motor is a series of coil-induced magnetic fields, each of which collectively induces rotation of the rotor and attached magnets. The motor can be designed with any number of stators, and any number of coils per stator, and any number of recycle coils which are adapted to receive collapsing field energy from one or more primary coils as described herein. Generally, each coil will require a distinct switching circuit, and optional recycling circuit.

In some embodiments, a motor generally comprises a rotor having one or more permanent magnets attached thereto, and further comprises one or more coils positioned above and below the rotor such that a magnetic field is directed perpendicular to the rotational axis. Any number of coils can be integrated depending on the motor application requirements. Moreover, the use of curved coils provides concentrated magnetic field in the desired region for improved performance.

Other designs and alternative embodiments will become apparent to those having skill in the art upon review hereof, thus the invention is intended to include any motor adapted with one or more of the features described herein.

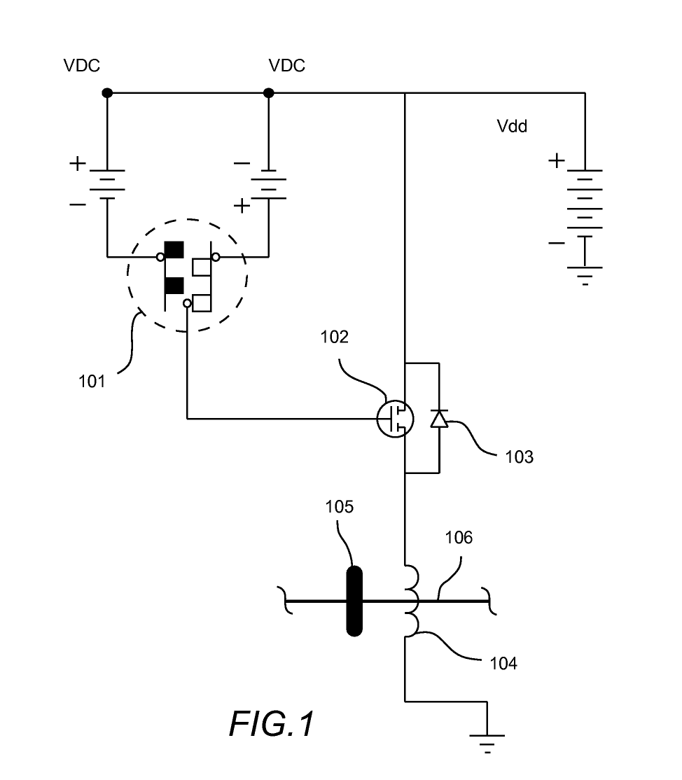

Now turning to the drawings, FIG. 1 shows a schematic of a compound dielectric motor in accordance with an embodiment. The schematic shows a general circuit topology of a compound dielectric motor. The circuit includes a power source VDC, such as one or more batteries in a battery bank or other power source, an axle switch 101 coupled to the power source, a MOSFET or other field effect transistor (FET) 102 coupled to the axle switch, a diode 103 coupled to the FET in parallel and configured to bridge the drain and source terminals of the FET, a voltage drain Vdd coupled between the diode and the voltage source, and an inductive coil 104.

Although only one inductive coil is shown, it should be noted that a plurality of inductive coils may be further provided arranged in series or other relationship to form a stator of the motor. Although the coils are shown in a static configuration, minor variations may be practiced to implement rotating coils.

A rotor 106 is partially illustrated, the rotor comprises at least one permanent magnet 105 coupled therewith. Although only one permanent magnet is shown, one or more permanent magnets may be attached to the rotor.

The axle switch 101 is at least partially coupled to the rotor. The axle switch functions as a single pole double throw switch for regulating current delivery to one or more inductive coils.

The motor is substantially free of iron core materials, and instead is made of dielectric core materials. This reduces loss associated with magnetic drag, hysteresis, and others.

The FET can include solid state components, such as a high voltage field effect transistor, or other components that one having skill in the art may determine. Such FET components are generally commercially available although never before implemented in the arrangement as shown in FIG. 1. The illustrated MOSFET is a P-Channel MOSFET, and has a source terminal S, drain terminal D, and gate terminal G.

The diode 103 serves to regulate the flow of current and can include any commercially available diode.

In the illustrated embodiment, a compound dielectric motor comprises a rotor having at least one permanent magnet coupled therewith; a switching circuit; and at least one inductive coil for generating a magnetic field used to rotate the rotor.

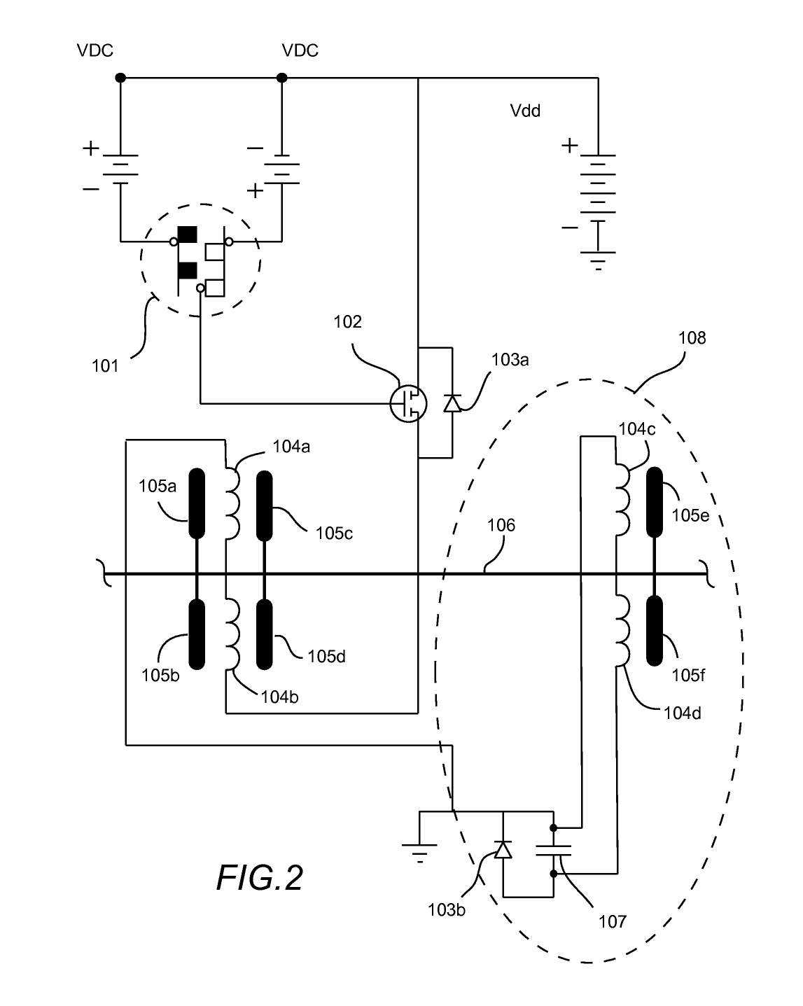

FIG. 2 shows a schematic of a compound regenerative dielectric motor in accordance with another embodiment. In this embodiment an additional regenerative circuit portion 108 is added. In this embodiment, the motor further comprises a plurality of permanent magnets 105(a-d) associated with the inductive coils 104(a-b) of a first motor section; and additional permanent magnets 105(e-f) associated with additional inductive coils 104(c-d). Although six magnets and four coils are shown, variations would be achieved by rearranging the number and position of inductive coils and permanent magnets in the motor. A primary difference in the illustrated circuit with relation to that of FIG. 1 is the regenerative portion 108. The regenerative portion comprises a second diode 103b coupled to a terminal lead of an inductive coil 104a. Note that there is a first diode 103a associated with the FET portion 102 of the primary circuit portion. The second diode 103b is distinct from the first diode. Here, energy from a collapsing field of one or more primary inductive coils 104(a-b) is delivered to the regenerative circuit portion, directed by the diode into a capacitive storage (capacitor 107) and subsequently used.

As illustrated in FIG. 2, energy from the collapsing field is redirected into a subsequent inductive coil, or pair of coils 104(c-d) for acting on a shared rotor. However, those having skill in the art will recognize that the energy of the regenerative circuit portion can be used to power a second motor, charge a power source, or otherwise used as a supplemental source of power for an electrical device.

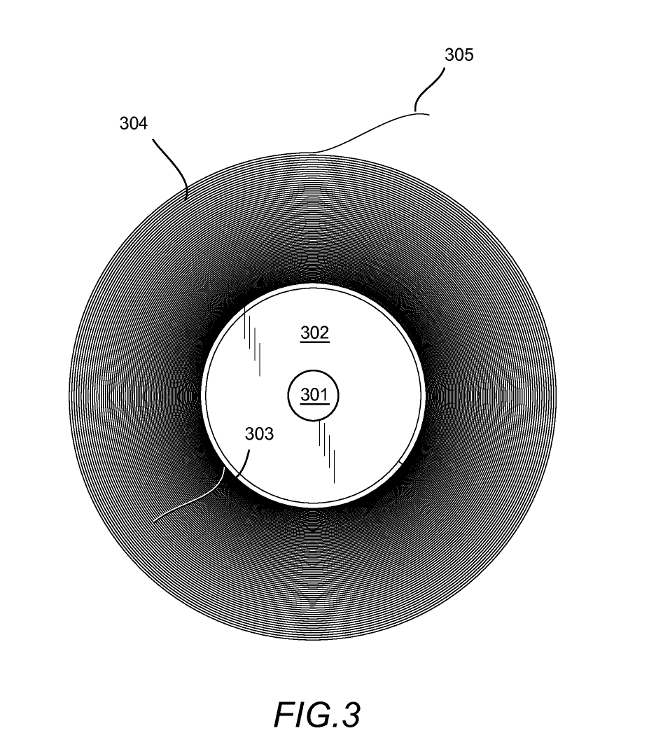

FIG. 3 shows a side view of an inductive coil for use in various embodiments. The inductive coil comprises a center 301; a dielectric core 302 extending radially from the center; a proximal conductor lead 303 continuously wrapped about the dielectric core to form a plurality of windings or turns 304; and ending with a distal conductor lead, or terminal end 305. The conductor can comprise a copper wire or other conductor. The wire forms at least fifteen hundred windings to be classified herein as a high-winding coil. The windings are evenly spaced and neatly turned to prevent large gaps between the windings since stored energy in the form of capacitance between the conductor windings is used in various embodiments. In a preferred embodiment, a thickness of the coil is equal to the diameter of the wire; but the thickness of the coil may be up to ten times the wire diameter, or more.

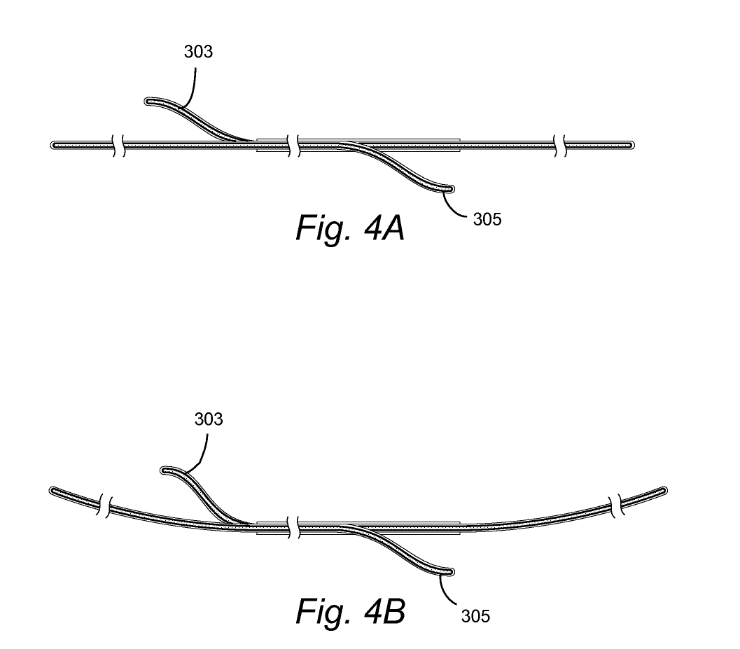

FIG. 4A shows a top view of a flat inductive coil. The flat inductive coil comprises a proximal end 303 wound about the dielectric core many times, and a terminal end 305. The flat inductive coil is substantially planar.

FIG. 4B shows a top view of a curved inductive coil. The curved inductive coil is similar to a flat coil, but bent or curved about a surface. In this regard, the magnetic moment expelled by the inductor coil can be better directed toward a desired permanent magnet for achieving improved motor performance. Note that the coil can have a parabolic shape, or the coil may form a hyperbolic paraboloid shape (not shown) in certain embodiments.

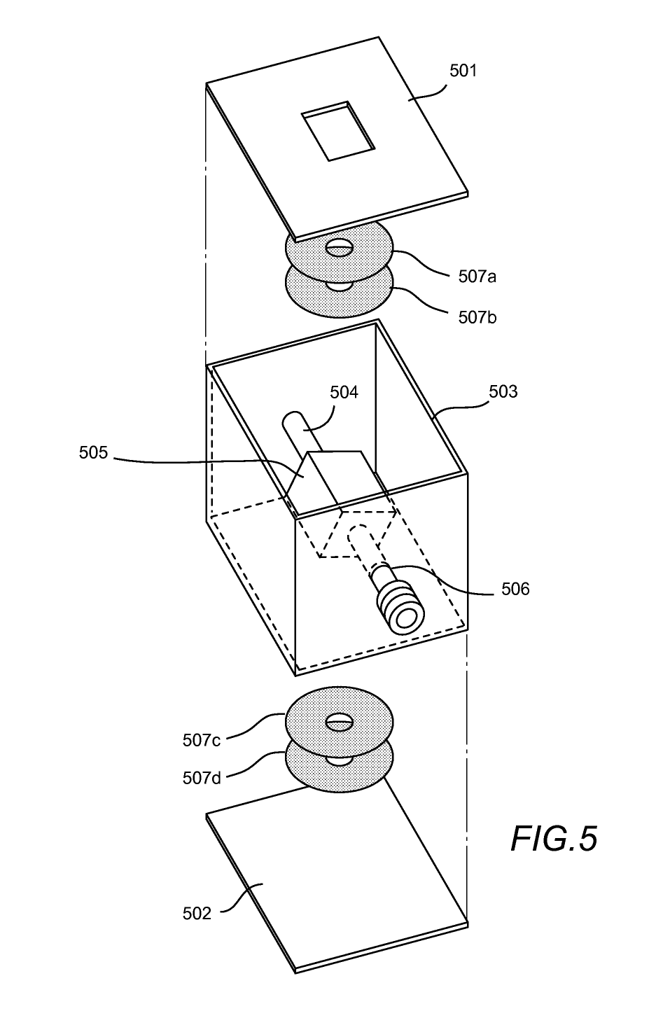

FIG. 5 shows a compound dielectric motor and various components in accordance with an embodiment herein referred to as a radial dielectric motor. The high efficiency dielectric radial dielectric motor may be configured as a compound dielectric motor, or as a compound regenerative dielectric motor as described above.

The radial motor comprises a top plate 501, a bottom plate 502 and a housing 503 collectively housing the motor components. The primary components of the radial motor include a rotor 504, a permanent magnet 505, and one or more inductive coils 507(a-d). The inductive coils can be flat or curved as described above, however, the curved coils provide improved performance and are therefore preferred. One or more bearings 506 can be used to join the rotor to the housing or other framework of the motor.

As shown, two coils 507(a-b) are positioned to a first side of the rotor (above) and two coils 507(c-d) are positioned to a second side of the rotor opposite of the first side (below). By providing paired coils the magnetic field is increased resulting in improved motor performance. Also, although not illustrated the coils can be disposed on the right and left sides, or otherwise, such that they are disposed on opposite sides of the rotor.

The radial motor as shown generally utilizes a schematic as illustrated in FIGS. 1-2, or a variation, to power the coils and form a magnetic field used to induce movement of the permanent magnet which is then translated to the rotor. The motor is substantially free of iron materials for reduced loss as described above.

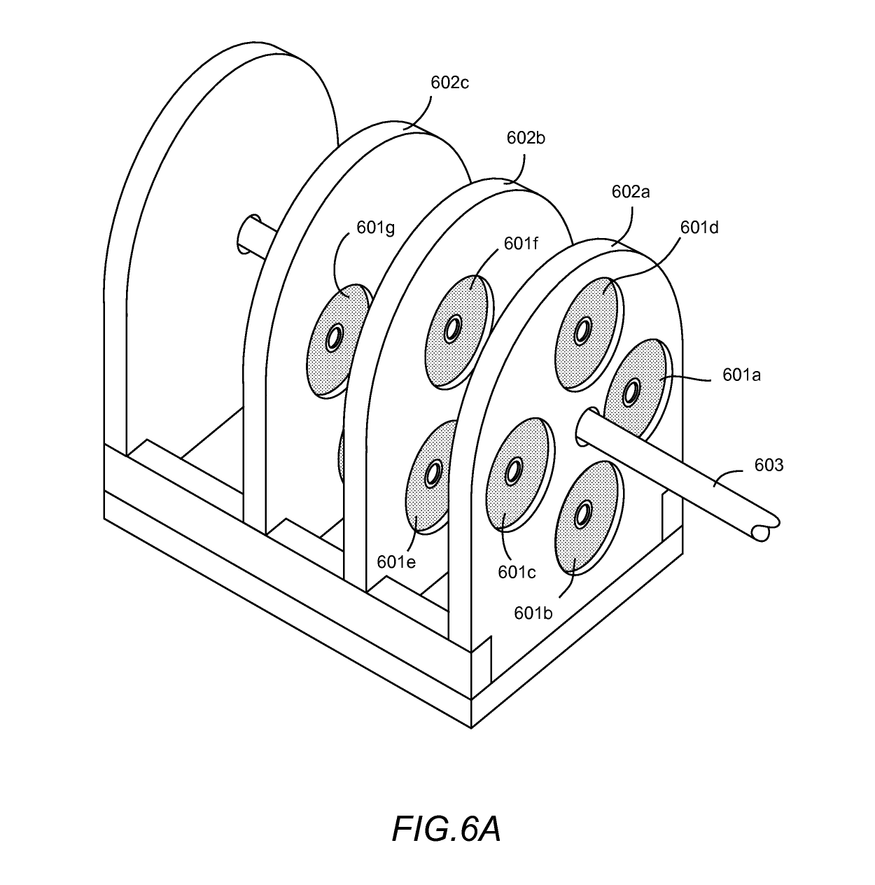

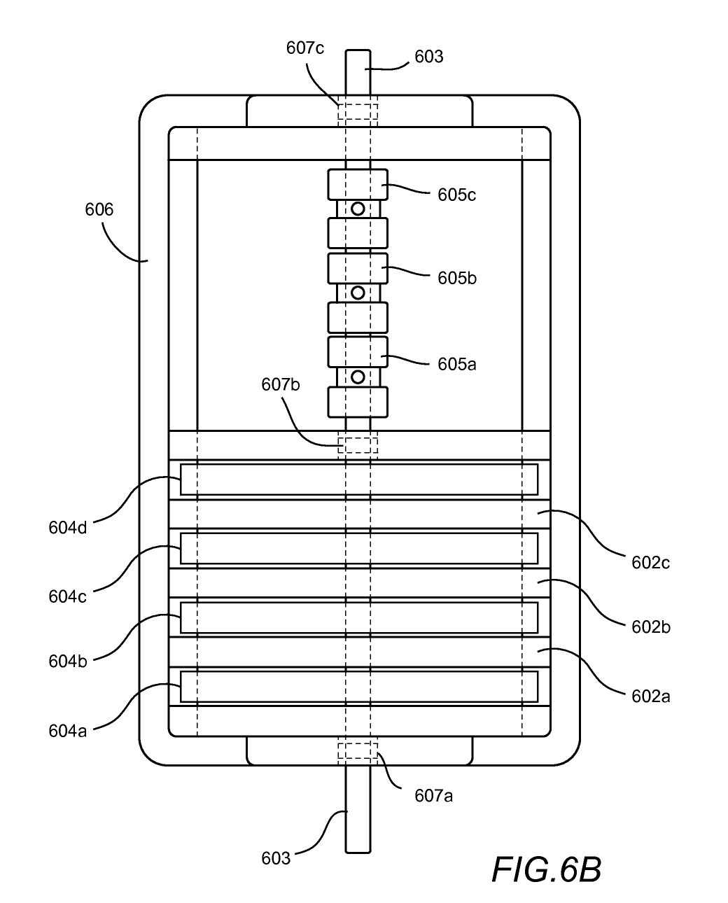

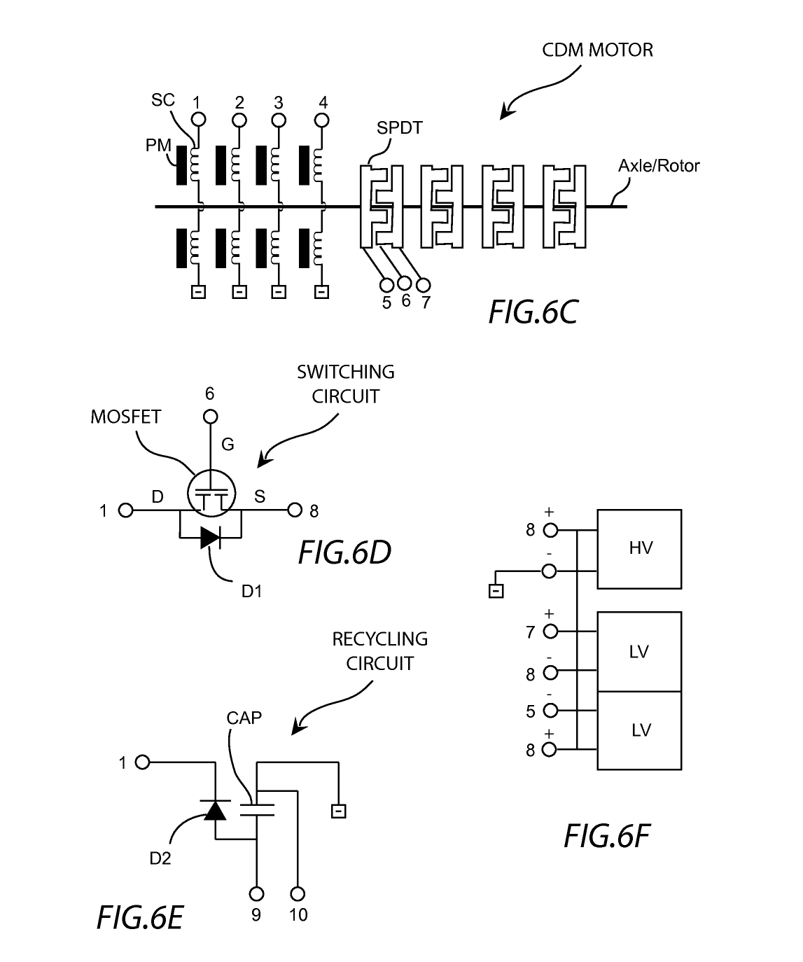

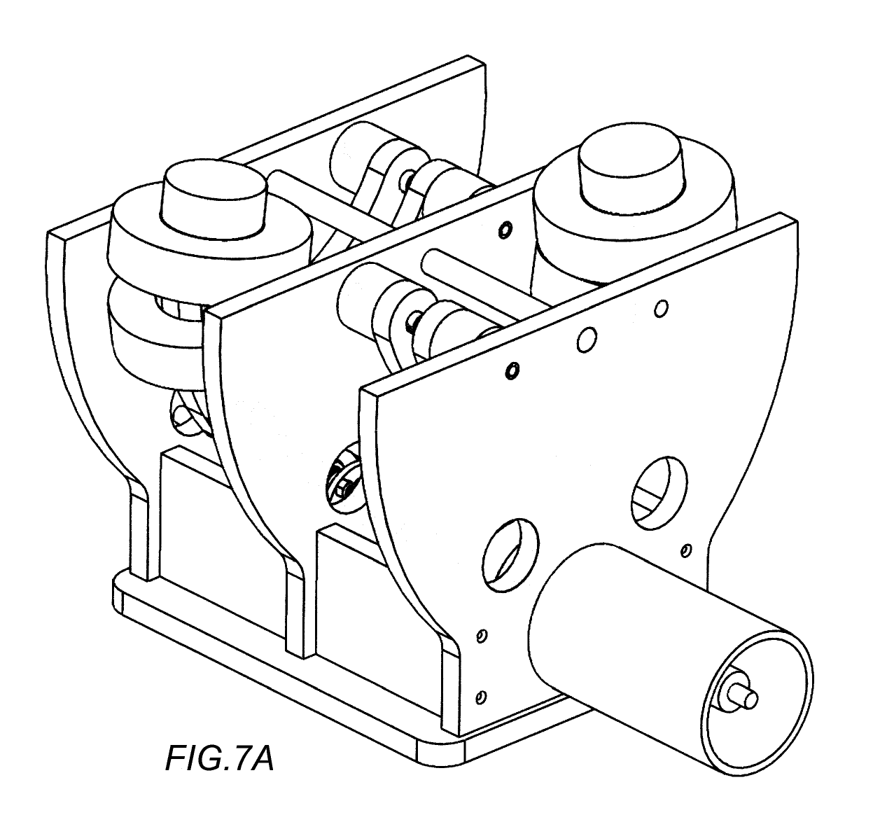

FIG. 6A shows a perspective view of a compound dielectric motor and various components in accordance with another embodiment termed herein as a “turbine motor” in relation to the arrangement of magnets and coils therein. As shown, the turbine motor comprises a plurality of stator panels 602(a-c), each of the stator panels comprising a plurality of inductive coils 601(a-g). The coils are oriented in an offset manner from stator to stator. A rotor 603 extends along a rotational axis through an aperture at the axial center of the turbine motor, such that the coils of each stator panel are radially disposed about the axial centerline.

FIG. 6B shows a top view of the compound dielectric motor in accordance with the embodiment of FIG. 6A. The housing 606 contains the motor components, including: the rotor 603, three stators 602(a-c), and a plurality of permanent magnets disc assemblies 604(a-d). Each permanent magnet disc assembly is attached to the rotor and spaced between respective stator panels. More specifically, multiple rotating discs are shown being attached to the rotor. The rotating disc may be a permanent magnet, or may include one or more permanent magnets affixed thereon. A plurality of axle switches 605(a-c) are illustrated as being attached to the rotor 603, the axle switches are shown being contained within a timing section of the motor. A plurality of bearings 607(a-c) can be used for mechanical stability and reduced rotor rotation resistance.

FIG. 6C shows a schematic of inductors, magnets, and switches in with a turbine motor similar to the embodiment of FIGS. 6(A-B). Note that four pairs of permanent magnets (PM) of the stator coil assemblies (SC) are each positioned adjacent to a corresponding inductive coils 1; 2; 3; 4, respectively, and each of the permanent magnets is attached to the rotor/axle. Additionally, there are four corresponding axle switches configured to for timing of the magnetic coils, such that individual coils are fired in a timing sequence. The axle switches are shown as single pole double throw axle switches (SPDT) with three leads 5; 6; 7, respectively; however the switches can be any axle switches. Each stator coil assembly requires a separate axle switch, and a separate switching circuit. If configured as a compound regenerative dielectric motor, each stator coil assembly will require a separate recycling circuit.

FIG. 6D shows a switching circuit in accordance with the embodiment of FIGS. 6(A-C). A field effect transistor, such as a MOSFET, has a drain terminal (D), source terminal (S), and a gate terminal (G). A diode D1 is configured to bridge the drain and source terminals.

FIG. 6E shows a recycling circuit in accordance with the embodiment of FIGS. 6(A-D). In the illustrated example, the recycling circuit comprises a diode directing current to a capacitor for storage of energy therein. In practice, the recycling circuit comprises a diode, at least one capacitor, and up to any number of additional passive components such as resistors, inductors, and the like, such that the recycling circuit is configured to provide a source of desired power to a subsequent coil, battery charger, or alternative electronic device. In the illustrated example, the capacitor is a high voltage electrolytic capacitor of mimimum ten microfarads.

FIG. 6F shows a voltage source in accordance with the embodiment of FIGS. 6(A-E). Note that for the turbine motor a voltage source includes a high voltage portion (HV) of 100-1000 V DC, and a low voltage portion (LV) of 12 V DC as shown.

The turbine motor can be used with a schematic circuitry similar to FIGS. 1-2.

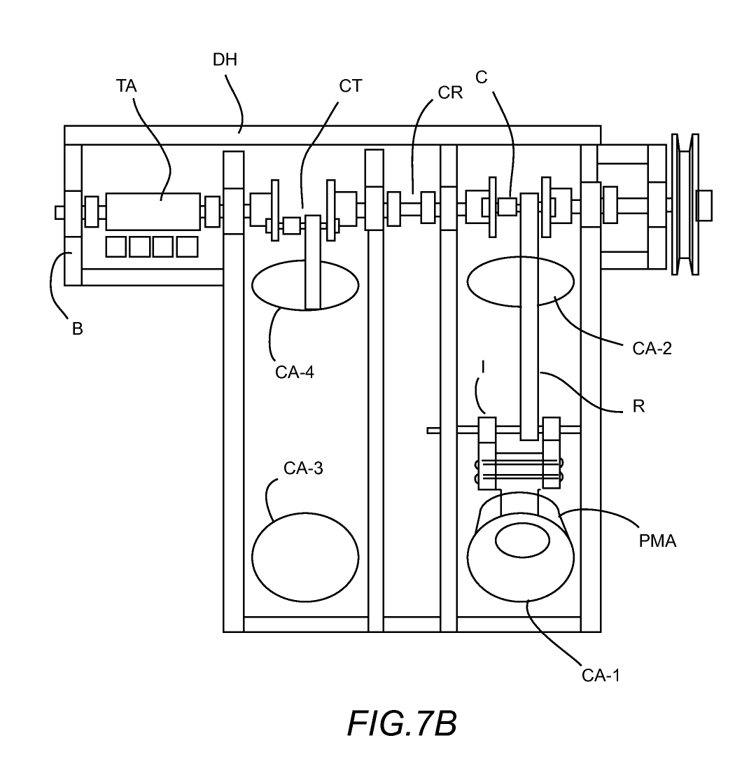

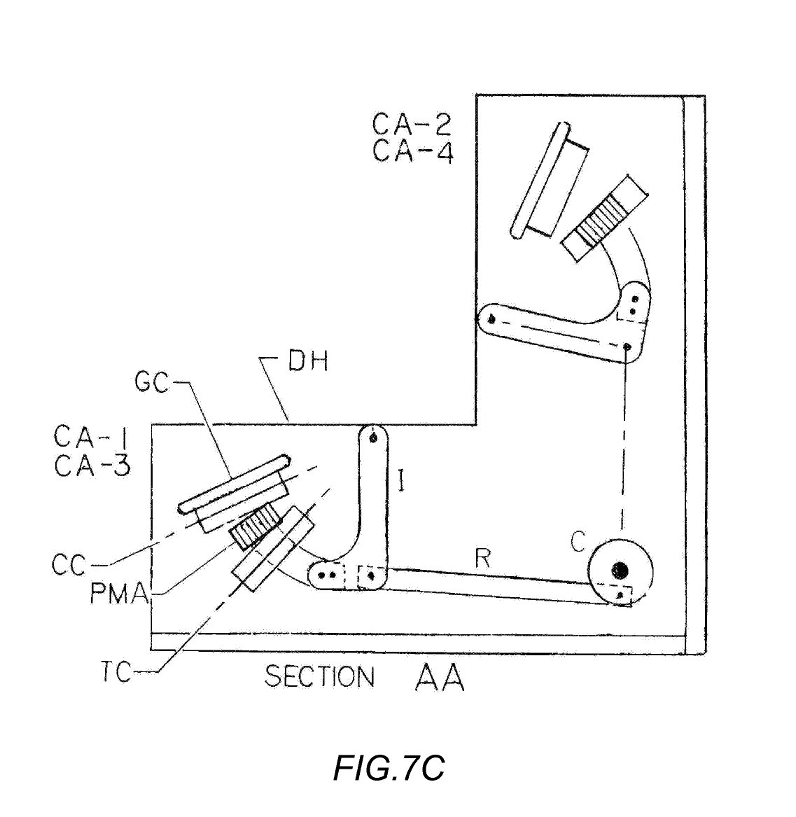

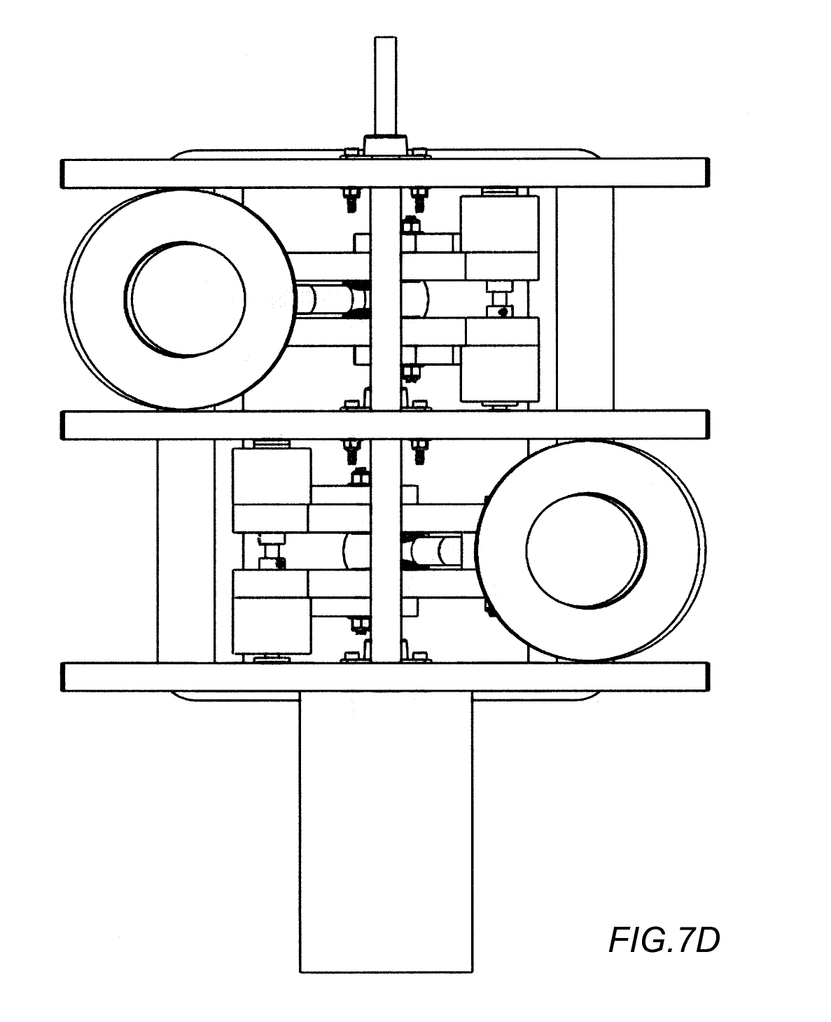

FIG. 7A shows a perspective view of a compound dielectric motor and various components in accordance with another embodiment termed herein as a “piston motor” as relating to the orientation of the motor components.

Similar to the above motors, the piston motor also uses high efficiency inductive coils as described herein, along with the circuitry of FIG. 1, FIG. 2, or similar circuit architecture. The piston motor notably resembles a modern v-type automobile engine, and thus may have applications such as an automobile power plant among other things.

FIG. 7B shows a side view of a compound dielectric motor and various components in accordance with the embodiment of FIG. 7A. Here, a crankshaft (C) extends along an axial length of the motor. One or more bearings (B) are used to enhance rotation about the motor housing. One or more aluminum or other non-ferrous rigid connecting rods (R) extend upwardly from the crankshaft to couple with a respective piston magnet assembly (PMA). A number of coil assemblies (CA-1 thru CA-4) are configured to induce a magnetic field for driving the respective piston magnet assemblies of the motor in a manner similar to the above embodiments. CA-1 and CA-2 are referred to herein as power piston coil assemblies since these coils drive the primary or power piston of the motor. CA-3 and CA-4 are referred to herein as recycle piston coils since these coils drive the recycle piston of the motor. In this regard, the recycle piston forms the regenerative portion of the motor. One or more collars and spacers (CR) can be used for mechanical stability, the collars and spacers can be fabricated from a composite material, aluminum or copper. An idler assembly (I) couples to a connecting rod that is attached to the crankshaft. A timing assembly (TA) comprises a plurality of axle switches and related components for coordinating timing of the coils with the circuitry, the timing assembly is generally attached to the crankshaft at a rear end thereof. The housing (DH) of the piston motor is generally fabricated form a dielectric material. Regarding crankshaft timing (CT), the recycle pistons are adjusted such that the end of the power piston cycle begins the start of the recycle piston cycle.

In one variation, one or more inductive coils are positioned within the piston bore, and a permanent magnet is attached to the piston. However, in another variation, the inductive coil may be positioned on the piston with the permanent magnet being fixed static about the housing; however in this embodiment running the wiring or trace elements adds difficulty. Accordingly it is preferred to house the coils in the dielectric housing of the motor.

In the illustrated version, the piston motor comprises a first coil disposed near a top of the piston bore, and a second coil disposed near a bottom of the piston bore. The permanent magnet (piston) is translated between the top and bottom of the piston bore in a mechanical fashion to turn the crankshaft. The first coil is used to drive the piston, and the second coil can be used either to further drive the piston or to decelerate the piston to absorb energy when the piston is near an end of the cycle.

Note that the each of the coils can be independently controlled to attract or repel a permanent magnet. Moreover, each of the coils can be independently configured as a primary coil, or using a regenerative circuit may be configured as a regenerative coil. In this regard, some of the energy of collapsing coils can be redirected into a subsequent coil and the motor will function as a compound regenerative dielectric motor.

One or more bearings and other known components can be implemented in line with current methods and the present state of the art.

FIG. 7C shows a front view of a compound dielectric motor and various components in accordance with the embodiment of FIGS. 7(A-B). The illustrated embodiment incorporates dielectric materials, high-winding inductive coils, and permanent magnets to replicate an architecture of the modern V-block engine.

FIG. 7D shows a top view of a compound dielectric motor and various components in accordance with the embodiment of FIGS. 7(A-C).

It can also be noted that depending on the orientation of coils and the wiring of the circuitry of the piston motor, that the individual pistons therein can be configured to not only provide a downward force for rotating the crankshaft, but may further exert an upward force for pulling on the crankshaft. This cycle can be implemented with opposing coils, and may utilize direct charging of inductive coils or alternatively may incorporate regenerative circuitry. Thus, although the motor may resemble the modern v-block engine used in automobiles, it is distinct in that each of the pistons can not only compress with force to drive the crankshaft, but they may further pull the crankshaft in an upward travel.

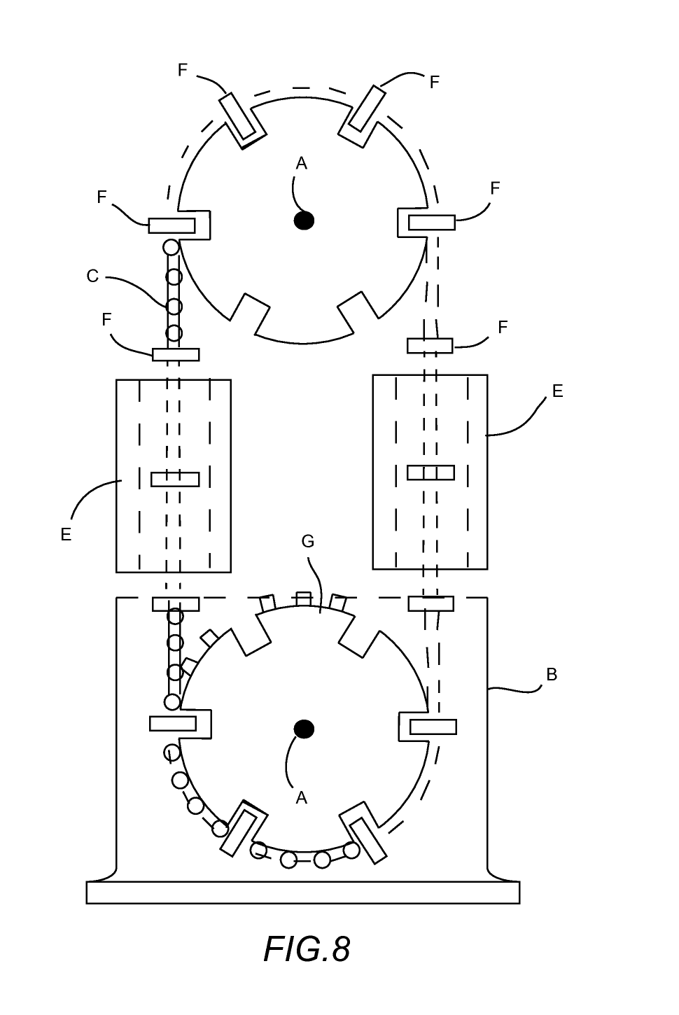

FIG. 8 shows a side view of a compound dielectric motor and various components in accordance with yet another embodiment referred to as a “concentric chain motor”. Two axles (A) are disposed one above another, each with a sprocket (G) attached thereto. The sprockets have radial slots along a circumference thereof for receiving permanent magnets (F) therein as the sprockets are cycled. Around the two sprockets is attached a chain (C) and a plurality of permanent magnet discs (F). The chain extends along two vertical sides, wherein two wells (E) are formed around the chain. One or more inductive coils can be positioned within each well and oriented for driving the chain and associated rotating sprockets. In this regard, the permanent magnets serve as a means for repulsion about the inductive coils, and further server as teeth for sprockets. All materials in the described embodiment are dielectric and substantially free of iron. The circuits of FIG. 1 and FIG. 2, or a similar circuit, can be used to drive the concentric chain motor.

The permanent magnets described herein are generally neodymium magnets, but may include any permanent magnet known in the art.

Each of the motors illustrated herein is substantially free of iron materials. In the described embodiments, iron materials are not required, and because such materials result in loss, such iron materials are generally discouraged for use in any of the aforementioned embodiments.

The motors described herein serve a variety of applications, from air conditioning motors, to automobile power plants, and anything in between. Although certain motor embodiments are illustrated herein, the invention is not limited to any of the illustrated embodiments.

Other designs and alternative embodiments will become apparent to those having skill in the art upon review hereof, thus the invention is intended to include any motor adapted with one or more of the features described herein.

1. A compound dielectric motor, comprising:
at least one dielectric coil,
the dielectric coil comprising: a dielectric core, and a conductive filament wrapped around the dielectric core to form at least 1500 windings,
said dielectric coil being further encapsulated in a dielectric substrate;
a rotor comprising an elongated rod having at least one permanent magnet coupled therewith;
the at least one dielectric coil being fixed within a housing to form a stator and configured to:
receive an electric current flowing through the conductive filament, and
produce a magnetic field through the coil, the magnetic field configured to induce rotational movement of the rotor via the at least one attached permanent magnet;
wherein the compound dielectric motor does not comprise ferrous materials such that the motor does not lose energy to resulting eddy currents or hysteresis.

2. The compound dielectric motor of claim 1, comprising two or more dielectric coils, said two or more coils comprising at least a first coil and a second coil.

3. The compound dielectric motor of claim 2, the first coil is disposed adjacent to the rotor at a first side thereof and configured to communicate a first magnetic field thereof to the permanent magnet coupled to the rotor; and the second coil is disposed adjacent to the rotor at a second side opposite of the first side and configured to communicate a second magnetic field thereof to the permanent magnet coupled to the rotor; wherein the first coil and second coil are each configured to alternate magnetic fields such that the rotor is configured to rotate continuously.

4. The compound dielectric motor of claim 2, further comprising a diode, said diode being coupled between the first coil and the second coil; wherein the diode is adapted to direct current from the first coil to the second upon collapsing an energy field thereof.

5. The compound dielectric motor of claim 1, wherein said conductive filament comprises a copper wire.

6. The compound dielectric motor of claim 1, wherein said dielectric substrate comprises a plastic resin.

7. The compound dielectric motor of claim 1, wherein said rotor comprises a copper alloy.

8. The compound dielectric motor of claim 2, wherein at least one of said coils comprises a curved coil.

9. The compound dielectric motor of claim 2,
the rotor extending along a rotational axis;
said motor further comprising:
at least one stator panel coupled to the motor housing, each stator panel comprising:
an aperture disposed at a center of the stator panel and configured to receive at least a portion of the rotor extending therethrough;
at least the first and second coils being disposed radially from the aperture;
wherein each of the first and second coils is oriented about the stator panel such that corresponding magnetic fields thereof are each communicated in a direction parallel with respect to the rotational axis; and
at least one rotor disc coupled to the rotor, each rotor disc comprising:
a volume extending radially from the rotor;
said volume comprising a permanent magnet of the at least one permanent magnet coupled to the rotor.

10. The compound dielectric motor of claim 9, comprising a bearing for coupling the rotor to one of the stator panels.

11. The compound dielectric motor of claim 9, comprising a plurality of stator panels, each of said stator panels comprising a plurality of coils.

12. The compound dielectric motor of claim 1, further comprising at least one axle switch coupled to the rotor for controlling current flow through the coils.

13. The compound dielectric motor of claim 12, further comprising a switching circuit, the switching circuit comprising a field effect transistor (FET) and at least one diode bridging a drain terminal and source terminal thereof.

14. The compound dielectric motor of claim 13, further comprising at least one recycling circuit coupled to one of the coils, the recycling circuit comprising: a diode, and one or more capacitors.

15. The compound dielectric motor of claim 14, wherein an output of said recycling circuit is coupled to any of: a subsequent coil for driving the rotor; a subsequent coil for driving a second and distinct motor; a battery charger and battery; or an additional electronic device.

16. The compound dielectric motor of claim 14, wherein each of the coils is individually coupled to a distinct axle switch, switching circuit, and recycling circuit.

17. The compound dielectric motor of claim 1, wherein said rotor comprises a cam shaft and each of said at least one permanent magnet is coupled to the rotor via a connecting rod extending therebetween.

18. A compound dielectric motor, comprising;
at least one dielectric coil,
the dielectric coil comprising: a dielectric core, and a conductive filament wrapped around the dielectric core to form at least 1500 windings,
said dielectric coil being further encapsulated in a dielectric substrate;
the at least one dielectric coil being fixed within a housing to form a stator and configured to:
receive an electric current flowing through the conductive filament, and
produce a magnetic field through the coil, the magnetic field configured to induce rotational movement of the rotor via the at least one attached permanent magnet;
wherein the compound dielectric motor does not comprise ferrous materials such that the motor does not lose energy to resulting eddy currents or hysteresis.

19. A compound dielectric motor, comprising:
at least a first dielectric coil and a second dielectric coil,
each of the dielectric coils comprising: a dielectric core, and a conductive filament wrapped around the dielectric core to form at least 1500 windings,
each of said dielectric coils being further encapsulated in a dielectric substrate;
a rotor comprising an elongated rod having at least one permanent magnet coupled therewith;
each of the dielectric coils being fixed within a housing to form a stator and configured to:
receive an electric current flowing through the conductive filament, and
produce a magnetic field through the coil, the magnetic field configured to induce rotational movement of the rotor via the at least one attached permanent magnet;
the motor further comprising:
at least one axle switch coupled to the rotor for controlling current flow through the coils;
at least one a switching circuit coupled between the at least one axle switch and one of the coils, the switching circuit comprising a field effect transistor (FET) and at least one diode bridging a drain terminal and source terminal thereof; and
at least one recycling circuit coupled to one of the coils, the recycling circuit comprising: a diode and one or more capacitors configured to communicate collapsing field energy of said one of the coils for subsequent reuse;
wherein the compound dielectric motor does not comprise ferrous materials such that the motor does not lose energy to resulting eddy currents or hysteresis.
